(19) United States
(12) Patent Application Publication
(10) Pub. No.: US 2024/0035637 A1
(43) Pub. Date: Feb. 1, 2024

(54) INJECTION-MOULDED PLASTIC COMPONENT FOR LIGHTING DEVICE WITH FUNCTIONAL SURFACE

(71) Applicant: VALEO VISION, Bobigny - Cedex (FR)

(72) Inventors: Laurent BARRE, Bobigny - Cedex (FR); Mathilde BERNARD-DE-LAVERNETTE, Bobigny - Cedex (FR)

(73) Assignee: VALEO VISION, Bobigny - Cedex (FR)

(21) Appl. No.: 18/255,974

(22) PCT Filed: Dec. 17, 2021
(86) PCT No.: PCT/EP2021/086665

§ 371 Date: Jun. 5, 2023

(30) Foreign Application Priority Data
Dec. 18, 2020 (FR) 2013712

(51) Int. Cl. F21S 41/20; B29C 45/00; B29C 45/16

(52) U.S. Cl. CPC F21S 41/28; B29C 45/0001; B29C 45/1657; B29K 2033/12

(57) ABSTRACT

A component of a lighting device for a motor vehicle includes a substrate composed of a first thermoplastic material, and a coating arranged on the substrate and composed of a second plastic material. The second plastic material includes polyurethane PUR, polyurea PU A or a combination of PUR and PU A.

### TECHNICAL FIELD

The invention relates to the field of injection-molded plastic components, in particular motor vehicle light devices.

### PRIOR ART

Motor vehicle light devices conventionally comprise a housing with an opening forming a connection interface, and an outer lens fixed to the housing via the connection interface and closing the opening. The housing is conventionally made of injection-molded opaque plastic material. The outer lens, usually made of glass in the past, has for some years been commonly made of injection-molded transparent plastic material, in particular polymethyl methacrylate PMMA, polycarbonate PC. These thermoplastic materials, commonly sold in the form of granules, are heated to a temperature exceeding the glass transition temperature, in order then to be injection-molded. However, they have a high viscosity and so require high injection pressures. A high injection pressure requires a suitable injection-moulding machine, which can greatly increase the manufacturing cost. This high viscosity imposes geometric limitations on the component to be produced, particularly when the latter has small-sized structuring, in particular a diffractive structure. In order to overcome this difficulty, it is known to form optical components based on silicone. These components often need to be attached to more robust ones. This solution is also quite expensive both from the point of view of the cost of the material and of its implementation.

It is also known to deposit protective layers of varnish on the outer surfaces of the outer lenses. These varnishes have an increased hardness in order to better resist external attacks that are likely to cause scratches. These varnishes have limitations that are inherent to varnishes, such as in particular limits of thickness, of function(s) and of implementation. They are also expensive, both from the point of view of raw material and from the point of view of their implementation.

### SUMMARY OF THE INVENTION

The object of the invention is to overcome at least one of the drawbacks of the aforementioned prior art. More particularly, the object of the invention is to produce plastic components of light devices having increased optical and mechanical properties and to do this in an economical manner.

The subject matter of the invention is a component of a motor vehicle light device, comprising a substrate made of a first thermoplastic material; a coating disposed on the substrate and made of a second plastic material; characterized in that the second plastic material is composed of polyurethane PUR, polyurea PUA or a combination of PUR and PUA.

The component of the light device can also have one or more of the following features, taken alone or in combination.

According to one advantageous embodiment of the invention, the first and second materials have between them, at an interface between said materials, polar bonds. These polar bonds are the result of reactive injection molding of the two materials, namely two separate injections but in the same manufacturing process where the second material is injected after the first material, that is to say when the latter has not yet cooled to room temperature, the second material crosslinking by chemical reaction of a polyol with an isocyanate.

According to one advantageous embodiment of the invention, the first thermoplastic material comprises polymethyl methacrylate PMMA, polycarbonate PC, a combination of PMMA and PC.

According to one advantageous embodiment of the invention, the substrate forms a wall with an average thickness that is greater than an average thickness of the coating.

According to one advantageous embodiment of the invention, the coating has an average thickness of between 0.1 and 10 mm, preferably of between 1 and 5 mm.

According to one advantageous embodiment, the substrate and the coating are transparent, each having a transmittance for visible light of at least 92%.

According to one advantageous embodiment of the invention, the second material is composed of PUA.

According to one advantageous embodiment of the invention, the second material is composed of PUR.

According to one advantageous embodiment of the invention, said component is an outer lens for closing the light device.

According to one advantageous embodiment of the invention, the coating forms an outer surface of said component, capable of self-repair by application of a source of heat to said coating.

According to one advantageous embodiment of the invention, the structure of the second material comprises an alignment and a superposition of short chains, of the order of a hundred to a few thousand carbon atoms, typically between a hundred and eight thousand carbon atoms. In other words, the second material exhibits the behavior of an oligomer.

According to one advantageous embodiment of the invention, the coating forms an inner surface of said component, provided with optical microstructures. By microstructures is meant structures or geometric shapes that have a main dimension of less than or equal to 10⁻³ mm. For this purpose, the microstructures may have nanometric dimensions. The microstructures can be optical, for example diffractive. The microstructures can also confer a hydrophobic function.

A further subject of the invention is a motor vehicle light device comprising a component according to the present disclosure.

A subject of the invention is a method for manufacturing a component of a motor vehicle light device, comprising the following successive steps: injection of a first thermoplastic material into a mold with a first geometry, so as to form a substrate; injection of a second plastic material into the mold with a second geometry, while the first material has not completely cooled to ambient temperature, so as to form a coating on the substrate; characterized in that the second plastic material is composed of polyurethane PUR, polyurea PUA or a combination of PU and PUA, in particular a combination of PUR and PUA.

The measures of the invention are advantageous in that they make it possible to produce components of a light device, in particular optical components, of complex shape while exhibiting particular mechanical and/or optical qualities, such as resistance to scratches and/or microstructures, respectively. The cost of production is also limited by the fact that the coating is thin in relation to the substrate, which is itself made of a less expensive thermoplastic material.

### BRIEF DESCRIPTION OF THE DRAWINGS

FIG. 1 is a sectional view of an outer lens of a light device, according to a first embodiment of the invention;

FIG. 2 is a sectional view of an outer lens of a light device, according to a second embodiment of the invention;

FIG. 3 is a schematic sectional view of a plastic injection-molding machine with a rotary mold, illustrating the injection of a first material, according to the invention;

FIG. 4 is a schematic sectional view of a plastic injection-molding machine with a rotary mold, corresponding to FIG. 3 but illustrating the injection of a second material, according to the invention.

### DETAILED DESCRIPTION

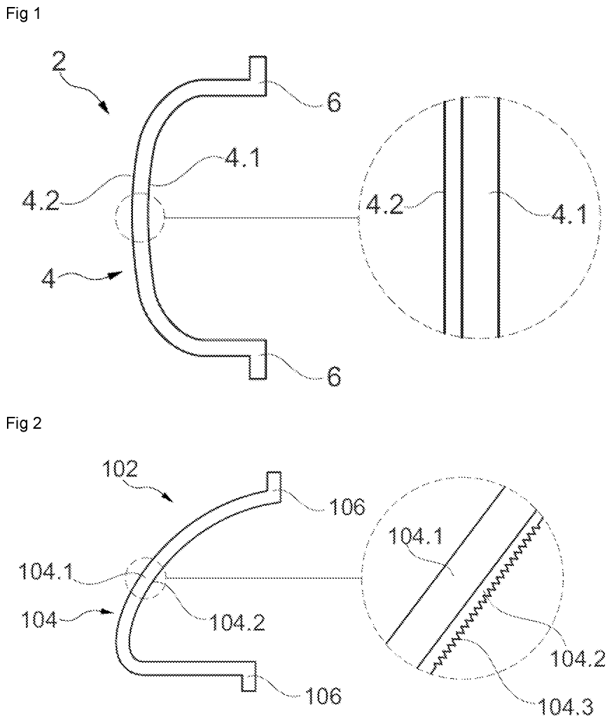

FIG. 1 is a schematic representation of a light device outer lens, according to a first embodiment of the invention.

The outer lens 2 comprises a transparent wall 4, and a foot 6 for fastening to a housing (not shown) of the light device. The wall 4 in this case forms a left-hand surface. The fastening foot 6 is formed integrally with the wall 4, at one edge of the latter. The wall 4 comprises a substrate 4.1 made of a first transparent plastic material of the thermoplastic type, for example polymethyl methacrylate PMMA, polycarbonate PC, or even a combination of PMMA and PC. The use of this type of material for this type of application is in itself well known. The substrate 4.1 is then produced by injecting the plastic material into a mold. The wall 4 further comprises a coating 4.2, which in this case forms an outer face of the outer lens 2. This coating has the function of forming a protective layer of the outer lens 2, that is to say of protecting it from external attack, in particular scratches. This coating 4.2 has properties of self-repair, that is to say an ability to reduce or eliminate damage such as scratches, by application of heat with a view to increasing its temperature. This property is known per se and is also commonly referred to by the term self-healing. To this end, the coating 4.2 is made of a second plastic material based on polyurea PUA. PUA is the product of a union between an isocyanate and various polyamines, more specifically a polyaddition of an aliphatic or aromatic isocyanate or of an isocyanate prepolymer to a polyfunctional amine or a mixture of amines. It is commercially available in particular from the company PANADUR® under the product name PANADUR CLEAR FAST. This product is a two-component product, namely a base component and a hardener. It is transparent and is commonly used as a coating of the “gelcoat” type for composite material comprising a matrix, such as a resin, and carbon or glass fibers.

The inventors of the present invention have discovered that a plastic material based on PUA can be injected with a substrate, such as the substrate detailed above, in order to form a coating that has protective properties for the substrate, thereby replacing potentially more expensive varnishes. The protective properties include a high degree of hardness, which can be adjusted by the ratio between the components of the PUA-based plastic material, and also by a self-healing or self-repairing capacity. This property is due to the structure of the plastic material in question, namely an alignment and a superposition of short chains, typically of the order of about a hundred carbon atoms. A scratch, such as a micro-groove formed by the movement of a pointed object on the coating, will separate these short chains on several superimposed layers. An increase in the temperature of the coating, by application of an external heat source (such as a hair dryer), typically to reach 60-90° C., will allow these short chains to reorganize by realigning themselves in a superimposed manner.

PUA has a low dynamic viscosity, typically of between 1.3 and 2 Pa·s at 20° C., close to that of water, favoring implementation by injection. Co-injection signifies that the first and second plastic materials are injected in the same manufacturing process, preferably in the same mold, but at different times, in order to allow the first plastic material, which is injected first, to solidify somewhat before the second plastic material is injected. The use of the same mold does not exclude the possibility that the substrate obtained by the first injection, namely of the first plastic material, is transferred into another cavity whose geometry is different, in order to perform the second injection therein, in this case of the second plastic material.

It should be noted that PUR is also able to be used, as a replacement for PUA, in the context of the first embodiment.

FIG. 2 is a schematic representation of a light device outer lens, according to a second embodiment of the invention.

The reference numbers of the first embodiment have been used to designate corresponding or identical elements of the second embodiment, these numbers however being increased by 100. Reference is moreover made to the description of these elements given in the context of the first embodiment.

The outer lens 102 differs from that of the first embodiment essentially in that the coating 104.2 of the wall 104 forms an inner face of said wall and forms a microstructure 104.3. The microstructure 104.3 advantageously has optical properties, in particular diffractive properties. The presence of optical microstructures on an inner face of a light device outer lens is in itself known to those skilled in the art. In the present case, this is obtained by a second plastic material forming a coating 104.2 of the substrate 104.1 made of a first thermoplastic material such as polymethyl methacrylate PMMA, polycarbonate PC, or a combination of PMMA and PC. The second plastic material can be based on polyurethane PUR injected onto the first plastic material. Such a plastic material is commercially available in particular from the company RÜHL Puromer GmbH, under the names Puroclear® 3351 IT and 3098/4IT with implementation with Puronate® 960/1. These materials are transparent with a transmittance of more than 92% and a low viscosity, of the order of 1 to 2.5 Pa·s at 25° C., i.e. very close to the viscosity of water. This plastic material is therefore particularly advantageous for an implementation by injection in order to form the microstructures 104.3.

The inventors of this invention have discovered that the use of PUR to form a coating by injection on a substrate, itself made of a thermoplastic material having a substantially higher viscosity in the molten state, not making it possible to produce fine structures such as optical microstructures, is possible and advantageous. The injection of thermoplastic material such as PMMA or PC presents difficulties when producing long components, since high injection pressures prove necessary. The high viscosity of the molten plastic material injected into a mold generates flow resistance forces which increase with the injection length from the point of entry of said material into the mould. This means that the injection pressure at the mold entrance, then potentially high, gradually decreases along this distance to the farthest end of the material in the course of injection However, the production of shapes with small details requires the application of a minimum of pressure to the injected material in order to completely fill these details. This is particularly the case for the production of microstructures. The molding by reactive injection of the substrate 104.1 in a first plastic material of the thermoplastic type and of the coating 104.2 forming microstructures 104.3 in a second plastic material with several components reacting after injection and having a low viscosity, in this case PUR, is therefore particularly advantageous.

It should be noted that PUA is also able to be used, replacing PUR, within the context of the second embodiment.

It is understood that it is possible to provide a first coating on a first face of the substrate, forming the outer face of the component, and a second coating on an opposite face of the same substrate, then forming the inner face of the component. Each of the first and second coatings can then be in accordance with one of the coatings in FIGS. 1 and 2.

In general, that is to say in particular for the first and second embodiments described above, the second plastic material is advantageously PUR, PUA, or a combination of PUR and PUA, essentially on account of their low dynamic viscosity allowing them to be injected without difficulty in thin layers. The substrate made of the first plastic material then forms the greater part of the component, in this case the outer lens. It can form at least 70%, preferably at least 80%, by mass of the component in question. The first plastic material, being inexpensive, thus makes it possible to limit the cost of production. PUR and PUA also have the advantage of being able to be transparent and thus of allowing the production of optical components such as the outer lenses of light devices described above or even glasses.

Generally, the coating can have an average thickness greater than or equal to 0.5 mm, preferably 1 mm, and/or less than 10 mm, preferably 5 mm. The substrate advantageously has an average thickness greater than the average thickness of the coating, more advantageously greater than 3 times the average thickness of the coating.

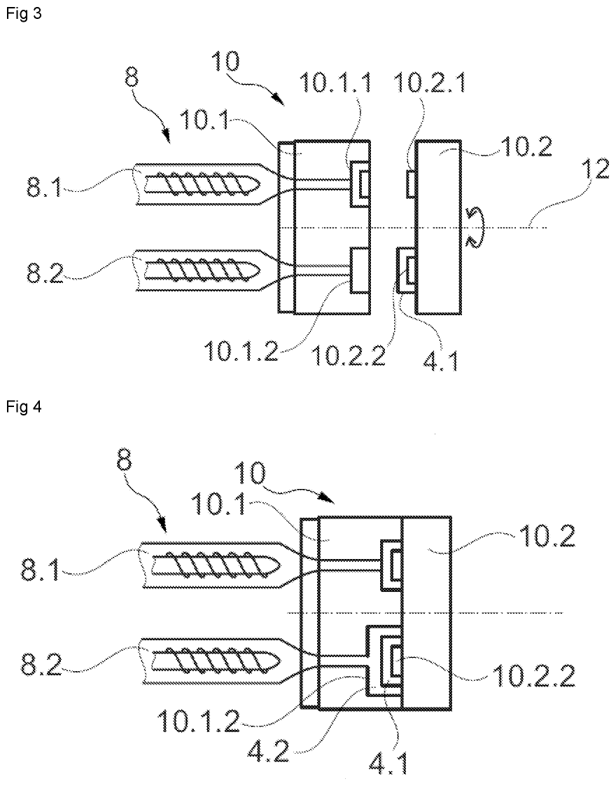

FIGS. 3 and 4 illustrate an embodiment of the injection of the first and second plastic materials, by means of a rotary mold.

FIG. 3 is a schematic sectional view of an injection-molding machine with a rotary mold. The injection-molding machine 8 comprises a first injection screw 8.1 for the first plastic material and a second injection screw 8.2 for the second plastic material. The rotary mold 10 comprises a fixed part 10.1 and a rotatable part 10.2. The fixed part 10.1 is fixed to the injection-molding machine 8 and comprises a first face 10.1.1 and a second face 10.1.2 different from the first face 10.1.1. The movable part 10.2 comprises, similarly, a first face 10.2.1 and a second face 10.2.2. Unlike the fixed part 10.1 of the mold 10, the first and second faces 10.2.1 and 10.2.2 are identical. The first face 10.1.1 of the fixed part 10.1 and one of the first and second faces 10.2.1 and 10.2.2 of the movable part 10.2 form, when the movable part 10.2 is disposed against the fixed part 10.1, a first cavity and injection geometry of the first plastic material, by means of the first injection screw 8.1 of the injection-molding machine 8, making it possible to produce the substrate 4.1. Once the substrate 4.1 has been injected and cooled, the movable part 10.2 of the mold moves in translation along the axis 12 so as to extract the substrate 4.1 in question remaining on the first face 10.2.1 of the movable part 10.2. The latter then undergoes a rotation, in this case of the order of 180°, so as to present the substrate 4.1 opposite the second face 10.1.2 of the fixed part 10.1 of the mold 10.

FIG. 4 illustrates the injection-molding machine and the mold from FIG. 3 at a stage where the second plastic material is injected by the second injection screw 8.2. The constituents of the second plastic material can be mixed in the injection screw before injection into the mold 10. For this purpose, the movable part 10.2 of the mold 10 is moved closer to the fixed part 10.1 so that the second face 10.2.2 of the movable part 10.2, carrying the substrate 4.1, engages with the second part 10.1.2 of the fixed part 10.1 of the mold 10, so as to form a second cavity and injection geometry delimited by said second part 10.1.2 of the fixed part 10.1 and the substrate 4.1. The second plastic material can then be injected therein so as to form the coating 4.2, the latter being deliberately represented with an exaggerated thickness, for the purposes of clarity of presentation. The first plastic material forming the substrate 4.1 is still hot when the second plastic material is injected, such that the two plastic materials have chemical cohesion at their interface. This chemical cohesion is in the absence of adhesive; it is achieved by covalent or polar bonds between the first and second plastic materials.

Alternatively, the constituents of the second plastic material can be mixed in a mixer attached to the injection-molding machine. The second plastic material is then transferred into the mold via a nozzle.

The process that has just been described is deliberately simplified in order to illustrate the principle by which the light device component is produced, according to the invention, by means of a rotary mold. It is however understood that it is possible to produce the light device component according to the invention in another way.

1. A component of a motor vehicle light device, comprising:
a substrate made of a first thermoplastic material;
a coating disposed on the substrate and made of a second plastic material;
wherein
the second plastic material is composed of polyurethane PUR, polyurea PUA or a combination of PUR and PUA.

2. The component as claimed in claim 1, in which the first and second materials have between them, at an interface between said materials, polar bonds.

3. The component as claimed in claim 1, in which the first thermoplastic material comprises polymethyl methacrylate PMMA, polycarbonate PC, a combination of PMMA and PC.

4. The component as claimed in claim 1, in which the substrate forms a wall with an average thickness that is greater than an average thickness of the coating.

5. The component as claimed in claim 1, in which the coating has an average thickness of between 0.1 and 10 mm.

6. The component as claimed in claim 1, in which the substrate and the coating are transparent, each having a transmittance for visible light of at least 92%.

7. The component as claimed in claim 6, in which said component is an outer lens for closing the light device.

8. The component as claimed in claim 1, in which the coating forms an outer surface of said component, capable of self-repair by application of a source of heat to said coating.

9. The component as claimed in claim 1, in which the coating forms an inner surface of said component, provided with optical microstructures.

10. Method for manufacturing a component of a motor vehicle light device, comprising the following successive steps:
injection of a first thermoplastic material into a mold with a first geometry, so as to forma substrate;
injection of a second plastic material into the mold with a second geometry, while the first material has not completely cooled to ambient temperature, so as to form a coating on the substrate;
wherein
the second plastic material is composed of polyurethane PUR, polyurea PUA or a combination of PU and PUA.

11. The component as claimed in claim 2, in which the first thermoplastic material comprises polymethyl methacrylate PMMA, polycarbonate PC, a combination of PMMA and PC.

12. The component as claimed in claim 2, in which the substrate forms a wall with an average thickness that is greater than an average thickness of the coating.

13. The component as claimed in claim 2, in which the coating has an average thickness of between 0.1 and 10 mm.

14. The component as claimed in claim 2, in which the substrate and the coating are transparent, each having a transmittance for visible light of at least 92%.

15. The component as claimed in claim 2, in which the coating forms an outer surface of said component, capable of self-repair by application of a source of heat to said coating.

16. The component as claimed in claim 2, in which the coating forms an inner surface of said component, provided with optical microstructures.

17. The component as claimed in claim 3, in which the substrate forms a wall with an average thickness that is greater than an average thickness of the coating.

18. The component as claimed in claim 3, in which the coating has an average thickness of between 0.1 and 10 mm.

19. The component as claimed in claim 3, in which the substrate and the coating are transparent, each having a transmittance for visible light of at least 92%.

20. The component as claimed in claim 3, in which the coating forms an outer surface of said component, capable of self-repair by application of a source of heat to said coating.
